(19) United States
(12) Patent Application Publication
(10) Pub. No.: US 2008/0217589 A1
(43) Pub. Date: Sep. 11, 2008

(54) Terminal composition for an electrical component

(76) Inventors: Tsung-Chih Tsai, Kaohsiung Hsien (TW); Hou-Hung Wei, Kaohsiung (TW)

Correspondence Address: Hershkovitz & Associates, LLC, 2845 Duke Street, Alexandria, VA, 22314, US

(21) Appl. No.: 11/715,384

(22) Filed: Mar. 8, 2007

(51) Int. Cl. H01B 1/02

(52) U.S. Cl. 252/519.21; 252/500; 252/518.1; 252/519.5

(57) ABSTRACT

A terminal composition for an electrical component has an organic material and an electrically conductive material. The organic material has a thermosetting plastic and an organic additive. The terminal is formed on at low temperature, so the terminal maintains its ductility and mechanical cushioning property. Furthermore, a cost of the terminal composition, especially the thermosetting plastic is inexpensive, so a cost of the electrical component will be reduced.

### BACKGROUND OF THE INVENTION

1. Field of Invention

The present invention relates to a terminal composition for an electrical component, and more particularly to a terminal composition formed in low temperature and with low cost.

2. Description of the Related Art

An electrical component such as a multi-layer ceramic capacitor is mounted on a circuit board and has a body and two terminals. The body has two ends, multiple ceramic layers and multiple internal electrode layers. The internal electrode layers are formed in the body and each internal electrode layer is formed between adjacent two ceramic layers and has a contacting end. The contacting ends of the internal electrode layers are exposed at the ends of the body. The terminals are formed and electrically contact respectively on the ends of the body in parallel.

A composition of each traditional internal electrode layer is made of noble metal such as silver, palladium or the like. Because the noble metal is expensive, inexpensive nickel or copper substitutes the noble metal. The terminals are made of copper that can fuse with nickel to form an alloy to allow electrons to transmit rapidly. However, the terminals made of nickel or copper are formed on the ends of the body at a temperature more than 600° C. After formed, the terminals will become hardened and can not resist stress so the terminals are easy to be damaged or generate a crack.

Moreover, the terminals can be made of a polymer containing silver (silver-based polymer) and can be formed at the ends of the body at a low temperature to maintain ductility and mechanical cushioning property. However, silver is expensive and if the terminals are formed directly on the body when the internal electrode layers are made of nickel or copper, the silver-based polymer will be hard to fuse with nickel. Thus, the electrons can not transmit fluently and the multi-layer ceramic capacitor performs inefficiently. Additionally, if a conducting layer is formed at each end of the body before the terminal is formed, a process to produce the multi-layer ceramic capacitor will be complex.

To overcome the shortcomings, the present invention provides a terminal composition for an electrical component to mitigate or obviate the aforementioned.

### SUMMARY OF THE INVENTION

The primary objective of the present invention is to provide a terminal composition for an electrical component, which is formed in low temperature and with low cost.

To achieve the objective, the terminal composition for an electrical component in accordance with the present invention has an organic material and an electrically conductive material. The organic material has a thermosetting plastic and an organic additive. The terminal is formed on at low temperature, so the terminal maintains its ductility and mechanical cushioning property. Furthermore, a cost of the terminal composition, especially the thermosetting plastic is inexpensive, so a cost of the electrical component will be reduced.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional side view of a first example of a structure of multi-layer ceramic capacitor with a terminal composition for an electrical component in accordance with the present invention; and

FIG. 2 is a cross sectional side view of a second example of a structure of multi-layer ceramic capacitor with a terminal composition for an electrical component in accordance with the present invention.

### DETAILED DESCRIPTION OF THE INVENTION

A terminal composition for an electrical component in accordance with the present invention has an organic material and an electrically conductive material to allow a terminal to be formed at a low temperature and low resistance. The low temperature is between 120° C. to 380° C. The volume resistivity is lower than 8×10⁻¹ ohm/cm at 25° C. A preferred volume resistivity is lower than 5×10⁻² ohm/cm at 25° C. A most preferred volume resistivity is lower than 3×10⁻³ ohm/cm at 25° C. The electrical component may be a capacitor such as a ceramic capacitor or a chip resistor. The ceramic capacitor may be a multi-layer ceramic capacitor such as a base metal electrode multi-layer ceramic capacitor (BME-MLCC's) or a disk capacitor. The organic material is in an amount from 10 wt % to 60 wt %, preferably from 15 wt % to 45 wt % and has a thermosetting plastic and an organic additive to maintain high ductility and high mechanical cushioning property. The thermosetting plastic is selected from a group consisting essentially of urea-formaldehyde resin (UF resin), epoxy resin, melamine-formaldehyde resin (MF resin), phenolic formaldehyde resin (PF resin), unsaturated ester, diallyl phthalate resins, a mixture thereof and a graft copolymer thereof. The organic additive is selected from a group consisting essentially of tackifier, plasticizer, wetting agent, solvent, disperse agent, defoaming agent, organic antioxidant and a mixture thereof.

The electrically conductive material is in an amount from 40 wt % to 90 wt %, preferably from 55 wt % to 85 wt % and has metallic powder and an inorganic additive to allow electrons to transmit rapidly.

The metallic powder comprises a first metallic powder and may have a second metallic powder. The first metallic powder may be selected from a group consisting essentially of copper, copper alloy, copper compounds and organic composite materials containing copper, may be selected from a group consisting essentially of silver, silver alloy, silver compounds and organic composite materials containing silver and may be selected from a group consisting essentially of nickel, nickelic alloy, nickelic compounds and organic composite materials containing nickel. The second metallic powder is selected from a group consisting of gallium (Ga), bismuth (Bi), tin (Sn), indium (In), zinc (Zn), cadmium (Cd), thallium (Tl), magnesium (Mg), aluminum (Al), lead (Pb), an alloy thereof or compound thereof. The metallic powder has multiple particles. The particles may be spherical, sheet-shaped or other irregular. Each spherical particle of the metallic powder is in a dimension from 0.01 μm to 15 μm and preferably from 0.05 μm to 10 μm. Each sheet-shaped particle of the metallic powder is in an average dimension from 0.01 μm to 50 μm and preferably from 0.3 μm to 30 μm. Each irregular particle of the metallic powder is in an average dimension from 0.01 μm to 30 μm and preferably from 0.1 μm to 10 μm.

The inorganic additive is metal with low melting point and is selected from a group consisting essentially of gallium (Ga), bismuth (Bi), tin (Sn), indium (In), zinc (Zn), cadmium (Cd), thallium (Ti), magnesium (Mg), aluminum (Al), lead (Pb), an alloy thereof and compound thereof.

The terminal is formed on at low temperature, so the terminal maintains its ductility and mechanical cushioning property. Furthermore, a cost of the terminal composition, especially the thermosetting plastic is inexpensive, so a cost of the electrical component will be reduced.

An embodiment of amounts of the organic material and the electrically conductive material is shown in Table 1:

TABLE 1

| Raw Material | Amount (Weight %) |
|---|---|
| Thermosetting resin | 12–35 |
| Copper sheet | 35–84 |
| Copper powder | 0.7–10.0 |
| Lead(inorganic additive) | 0.1–5.0 |
| Terpineol (organic additive 1) | 3.0–7.0 |
| Adhesive(organic additive 2) | 1.0–5.0 |
| Disperse agent(organic additive 3) | 0.2–3.0 |

### EXAMPLE 1

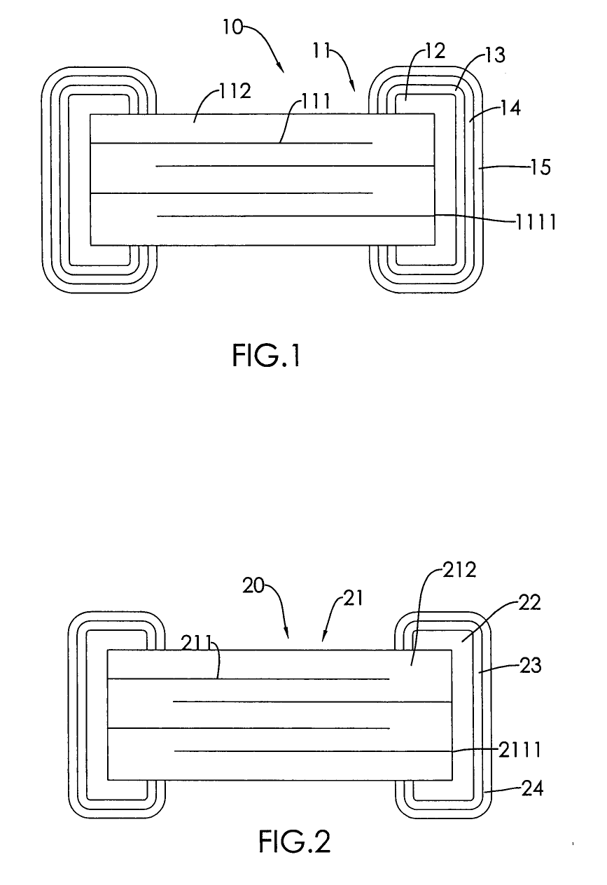

With reference to FIG. 1, a multi-layer ceramic capacitor (10) has a body (1 1) and two terminals. The body (11) has two ends, multiple dielectric layers (112) and multiple internal electrode layers (111). The internal electrode layers (111) are formed in the body (11) and each internal electrode layer (111) is formed between adjacent two dielectric layers (112) and has a contacting end (1111) exposed at one of the ends of the body (11). The terminals are formed respectively on the ends of the body (11) and each terminal has an electrode layer (12), a cushioning layer (13), a protecting layer (14) and a connecting layer (15). The electrode layer (12) is formed at one of the ends of the body (11) and electrically contacts the contacting ends (1111) of the internal electrode layers (111). The cushioning layer (13) is formed on the electrode layer (12), is made of thermosetting resin and metal composite material of the terminal composition of the present invention to maintain ductility and reduces a cost of the multi-layer ceramic capacitor (10). The metal composite material is in an amount of 30˜70 wt %. The cushioning layer (13) has a thickness of 0.1˜800 μm and a preferred thickness of 1˜500 μm. The production layer (14) is formed on the cushioning layer (13) and may be made of nickel. The connecting layer (15) is formed on the protecting layer (15) and may be made of tin.

### EXAMPLE 2

With reference to FIG. 2, the multi-layer ceramic capacitor (20) of the present invention has a body (21) and two terminals. The body (21) has two ends, multiple dielectric layers (212) and multiple internal electrode layers (211). The internal electrode layers (211) are formed in the body (21) and each internal electrode layer (211) is formed between adjacent two dielectric layers (212) and has a contacting end (2111) exposed to the ends of the body (21). The terminals are formed respectively at the ends of the body (21) and each terminal has a cushioning layer (22), a protecting layer (23) and a connecting layer (24). The cushioning layers (22) are formed respectively at the ends of the body (21) and connect electrically to the contacting ends (2111) of the internal electrode layer (211) in parallel. Each cushioning (22) is made of the terminal composition of the present invention to maintain ductility and reduces a cost of the multi-layer ceramic capacitor (10). The cushioning layer (13) has a thickness of 0.1˜800 μm, a preferred thickness of 1˜500 μm and a most preferred thickness of 5˜400 μm. The protecting layer (23) is formed on the cushioning layer (22). The connecting layer (24) is formed on the protecting layer (23).

The terminal of example 2 only has three layers because the cushioning layer (22) is electrically conductive and also has mechanical cushioning property. Thus, the terminal of the multi-layer ceramic capacitor (20) not only maintains ductility but also has a thin thickness to reduce a cost of the multi-layer ceramic capacitor (20).

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A terminal composition for an electrical component comprising:
an organic material having
a thermosetting plastic; and
an organic additive; and
an electrically conductive material.

2. The terminal composition for an electrical component as claimed in claim 1, wherein the electrically conductive material has
metallic powder comprising a first metallic powder; and
an inorganic additive.

3. The terminal composition for an electrical component as claimed in claim 1, wherein
the organic material is in an amount from 10 wt % to 60 wt %; and
the electrically conductive material is in an amount from 40 wt % to 90 wt %.

4. The terminal composition for an electrical component as claimed in claim 1, wherein
the organic material is in an amount from 15 wt % to 45 wt %; and
the electrically conductive material is in an amount from 55 wt % to 85 wt %.

5. The terminal composition for an electrical component as claimed in claim 1, wherein the thermosetting plastic is selected from a group consisting essentially of urea-formaldehyde resin, epoxy resin, melamine-formaldehyde resin, phenolic formaldehyde resin, unsaturated ester, diallyl phthalate resins, a mixture thereof and a graft copolymer thereof.

6. The terminal composition for an electrical component as claimed in claim 1, wherein the organic additive is selected from a group consisting of tackifier, plasticizer, wetting agent, solvent, disperse agent, defoaming agent, organic antioxidant and a mixture thereof.

7. The terminal composition for an electrical component as claimed in claim 2, wherein the first metallic powder is selected from a group consisting of copper, copper alloy, copper compounds and organic composite materials containing copper.

8. The terminal composition for an electrical component as claimed in claim 2, wherein the first metallic powder is selected from a group consisting of silver, silver alloy, silver compounds and organic composite materials containing silver.

9. The terminal composition for an electrical component as claimed in claim 2, wherein the first metallic powder is selected from a group consisting of nickel, nickelic alloy, nickelic compounds and organic composite materials containing nickel.

10. The terminal composition for an electrical component as claimed in claim 2, wherein the metallic powder further comprises a second metallic powder selected from a group consisting of gallium (Ga), bismuth (Bi), tin (Sn), indium (In), zinc (Zn), cadmium (Cd), thallium (Tl), magnesium (Mg), aluminum (Al), lead (Pb), an alloy thereof and compound thereof.

11. The terminal composition for an electrical component as claimed in claim 8, wherein the metallic powder further comprises a second metallic powder selected from a group consisting of gallium (Ga), bismuth (Bi), tin (Sn), indium (In), zinc (Zn), cadmium (Cd), thallium (Ti), magnesium (Mg), aluminum (Al), lead (Pb), an alloy thereof and compound thereof.

12. The terminal composition for an electrical component as claimed in claim 9, wherein the metallic powder further comprises a second metallic powder selected from a group consisting of gallium (Ga), bismuth (Bi), tin (Sn), indium (In), zinc (Zn), cadmium (Cd), thallium (Ti), magnesium (Mg), aluminum (Al), lead (Pb), an alloy thereof and compound thereof.

13. The terminal composition for an electrical component as claimed in claim 2, wherein the inorganic additive is metal with low melting point.

14. The terminal composition for an electrical component as claimed in claim 13, wherein the inorganic additive is selected from a group consisting essentially of gallium (Ga), bismuth (Bi), tin (Sn), indium (In), zinc (Zn), cadmium (Cd), thallium (Ti), magnesium (Mg), aluminum (Al), lead (Pb), an alloy thereof and compound thereof.
